(19) United States
(12) Patent Application Publication
(10) Pub. No.: US 2021/0241029 A1
(43) Pub. Date: Aug. 5, 2021

(54) FORM OF ARTIFICIAL INTELLIGENCE AND TRAINING METHOD THEREOF

(71) Applicants: Andrew Polar, Duluth, GA (US); Michael Poluektov, Coventry (GB)

(72) Inventors: Andrew Polar, Duluth, GA (US); Michael Poluektov, Coventry (GB)

(21) Appl. No.: 16/781,657

(22) Filed: Feb. 4, 2020

(51) Int. Cl. G06K 9/62; G06F 9/30

(52) U.S. Cl. CPC G06K 9/6247; G06K 9/6215; G06K 9/6263; G06F 9/3001; G06K 9/6282

(57) ABSTRACT

A method for identification of multiple discrete Urysohn operators, arranged in a tree and connected in both parallel and sequential ways, capable of replacing adequately any continuous multivariate function, which may be considered as a generic tool for mapping an ordered data into a scalar, and used as training process for artificial intelligence.

### CROSS-REFERENCES TO RELATED APPLICATIONS

Not Applicable

### FEDERALLY SPONSORED RESEARCH OR DEVELOPMENT

Not Applicable

### SEQUENCE LISTING OR A COMPUTER PROGRAM

Not Applicable

### BACKGROUND OF INVENTION

### Field of Invention

Artificial intelligence exists in multiple different forms. One of them is mapping of data structures into a variable. For example, approval of loan applications. The data provided by an applicant is a vector that is mapped into a variable from interval [0,1], which is a degree of certainty that the loan will be paid off.

More complex systems, such as driverless cars or board games, e.g. chess, cannot be reduced to simple data mapping, but may include it internally as elementary blocks.

This invention is both a new model and a new data mapping method for model training. The model maps vectors into scalars, and the method tunes the model parameters with a controllable accuracy, given the training data sets.

### FIGS. 1-3—Prior Art

The suggested method is a further development of the previous research by the authors of this invention (M. Poluektov and A. Polar) and (U.S. patent application), which is the identification method for the discrete Urysohn model. The model converts given input vectors into given scalars with the best possible accuracy retaining the assigned structure.

Prior art cited in [0007] is, in turn, an upgrade of the Least Mean Squares (LMS) method introduced in early 1960s. The LMS method (and its variations) is applied to models, which are linear relative to estimated parameters. A single data record of such model represents vector X and scalar Y. The model is defined by a weight vector W, such that inner product <W,X> equals to Y with the best possible accuracy for the selected records used as a training set. The model vector W, according to the LMS, is constructed by its slight modification for each different data record either new or used earlier.

The Urysohn model, cited in [0007], is shown in FIG. 1. The data record represents also a vector and a scalar, and the model is a set of functions applied to each individual element. The method, suggested in the prior art, allows building the functions of FIG. 1 without prior assumptions regarding their shapes but with the few limitations. Such limitation, for example, can be piecewise linearity as shown in FIG. 2 (not necessarily with equal intervals between points). In prediction or identification step the known argument falls into a particular interval. The relative distance within the interval (denoted by p in FIG. 2) is also known and the model can be expressed as a sum of multiple addends, one of which is shown in FIG. 3. Relative distance p means that it is measured within linear block and divided by the abscissa length of the block, so it takes values from interval [0,1]. The novel approach of the prior art allows expressing nonlinear functions in FIG. 1 as a linear combination of the estimated parameters, which are not multipliers as in the linear regression model, but unknown function values in selected points.

### Objects and Advantages

The Urysohn model is a significant generalization compared to the linear regression model or to the Hammerstein model. The model of FIG. 1 turns into the linear regression only in a particular case, if every function is linear and if it crosses the origin. Unfortunately, in spite of being more general than the linear case, model of FIG. 1 is not generic enough to be considered as an artificial intelligence. It fails, for example, if the output (or the target) is a product of all elements of the input vector. The primary aim of this invention is to upgrade the data modelling approach even further and provide the model and the method capable of mapping an input vector into an output scalar close to the provided value, when this value depends on input but in some unknown and complicated way. The secondary aim is to provide an ability of human intervention for manual correction of the model parameters. This feature is not available in neural networks, where researchers cannot assess the contribution of each individual parameter of the constructed model to the output.

### BRIEF SUMMARY OF INVENTION

This invention represents a method for identification of the hierarchical tree of functions arranged in such a way that sums of several function values are arguments for the others. The method is applicable for modelling of input/output relationship where small differences in input elements result in small differences of output scalar.

### BRIEF DESCRIPTION OF SEVERAL VIEWS OF THE DRAWINGS

FIG. 1 shows the Urysohn model.

FIG. 2 shows one of the functions of the model of FIG. 1 in a piecewise linear form with its argument marked by a vertical line.

FIG. 3 shows one of the terms in formula in FIG. 1 expressed by notations introduced in FIG. 2, which are weights and function values in nodes.

FIG. 4 shows the Kolmogorov-Arnold representation for a continuous multivariate function.

FIG. 5 shows the condition for choosing an increment for the argument in the Kolmogorov-Arnold representation used in the invention method.

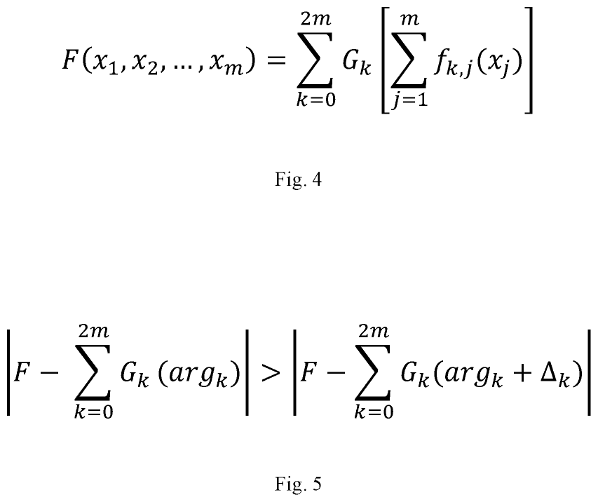

### DETAILED DESCRIPTION—FIGS. 4,5—PREFERRED EMBODIMENT

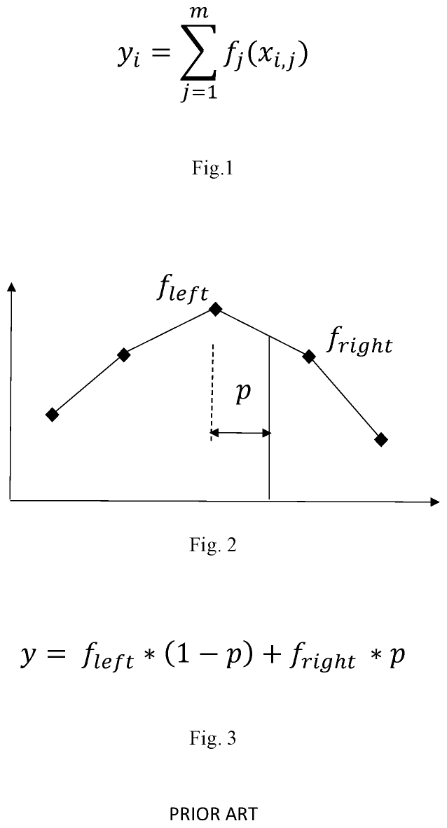

One of the common tasks of data modelling is identification of multivariate function F shown in the left-hand side in FIG. 4. The expression in the right-hand side of FIG. 4 is the Kolmogorov-Arnold representation and dates back to late 1950s, when it has been proven that every continuous multivariate function can be adequately replaced by a tree of functions of one variable. By comparing FIG. 4 and FIG. 1 it is possible to conclude that the Kolmogorov-Arnold representation is a tree of the discrete Urysohns operators. One of them is root operator G and the others are branch operators, which deliver inputs to G. Inputs of G are outputs in the row of branches, and all inputs for branch operators are the same and are arguments of F.

An individual Urysohn operator can be identified according to prior art method introduced earlier by the authors of this invention (M. Poluektov and A. Polar) by processing the input/output data. However, the inputs for G, which are at the same time the outputs of the branches, are unknown and cannot be obtained from observation or measurement in principle, since they are auxiliary mathematical variables.

This problem of unknown intermediate parameters in two or more sequential discrete Urysohn operators is a subject of this invention. The suggested resolution is to start from an initial approximation and update the model for each obtained data set. This update needs, in turn, multiple steps: compute intermediate inputs for the root operator; having them, compute the final output; compare it to actual output F; find increments or decrements (denoted as Greek letter delta in FIG. 5), which reduce the discrepancy for the root operator; and use these increments or decrements as the directions for tuning of the branch operators.

Elaborating [0019] in a more detailed form, it can be added that the values denoted as “arg” in FIG. 5 are the outputs of the branches and they are computed by inputs and current branch operators. These computed “arg” values fall into particular linear blocks of the individual functions of root operator G and small increments or decrements denoted as “delta”, which contribute to reduction of the magnitude of difference between modeled and actual value can be found easily. Considering these new arguments “arg”+“delta” as desired output for branch operators, they all are updated according to the prior art method developed for the single Urysohn operator. After all branch operators are updated, new intermediate inputs for G are computed and root operator G is then updated. The magnitudes of “delta” are not critical, they are simply chosen small relatively to the range of the arguments “arg”, but their sign is critical, since it shows in which direction each branch operator must be updated. There is a similarity with the gradient descent method; the difference is that proposed method is applied to auxiliary intermediate variables that do not exist and, when the directions are found, the operators that deliver these auxiliary variables are updated. In the classic gradient descent method, the model parameters are incremented while inputs and outputs stays unchanged.

The method suggested in this invention is not limited to the Kolmogorov-Arnold representation but applicable to any multiple Urysohn operators arranged in a tree. This invention builds a tree of interconnected Urysohn operators in the exact form as Kolmogorov-Arnold representation expresses it, when each individual function of the model is identified as a function and its shape is determined in identification process. Having model expressed by functions opens up an opportunity for human intervention and manual modification of parameters by skilled researchers who understand underlying principles of a modeled object.

### REFERENCES

M. Poluektov and A. Polar. Modelling of Non-linear Control Systems using the Discrete Urysohn Operator. Published online at arxiv.org, arXiv: 1802.01700, Feb. 5, 2018.
U.S. patent application Ser. No. 15/998,381, filed Aug. 11, 2018. Method for identifying discrete Urysohn models.

We claim:

1. A method of constructing a tree of the discrete Urysohn operators capable of mapping provided ordered data sets into provided scalars by accomplishing multiple steps for each individual data set including but not limited to:
(a) provided a model approximation and a data to be modeled, computing a difference between a model predicted scalar and an actual value,
(b) identifying a direction for an incrementing of all inputs for a root operator of said tree needed for reduction of the said difference between said model predicted scalar and said actual value,
(c) having all these directions for all said inputs of said root operator, update all branch operators which deliver these said inputs to said root operator in such a way that the branch outputs, which are the inputs of said root operator, become incremented into said identified directions and therefore reduce said absolute difference between the updated model and the provided data set compared to said difference before execution of this update step.
